(19) United States
(12) Patent Application Publication
(10) Pub. No.: US 2005/0049818 A1
(43) Pub. Date: Mar. 3, 2005

(54) Dynamic clock pulse adjusting device

(76) Inventors: Hsing-Wang Liang, Jung-He City (TW); Tsung-Hung Tsai, Jung-He City (TW)

Correspondence Address: BIRCH STEWART KOLASCH & BIRCH, PO BOX 747, FALLS CHURCH, VA, 22040-0747, US

(21) Appl. No.: 10/653,166

(22) Filed: Sep. 3, 2003

(51) Int. Cl. G06F 15/00

(52) U.S. Cl. 702/132

(57) ABSTRACT

A dynamic clock pulse adjusting device is disclosed. It is comprised of a detection mechanism, a logic circuit, and a clock pulse generator. The detection mechanism performs real-time detection of the work temperature or load of the CPU. The logic circuit determines whether the work temperature or load exceeds a predetermined threshold. The clock pulse generator then adjusts the frequency of the output clock pulses, so as to increase or reduce the CPU work frequency.

### BACKGROUND OF THE INVENTION

1. Field of Invention

The invention pertains to a dynamic clock pulse adjusting device and, in particular, to a device that detects the real-time work conditions of a CPU and thereby adjusts its work frequency.

2. Related Art

The development of information technologies facilitates people's uses of information processing devices for daily tasks. The applications range from national governments, business systems, to families and individuals. To increase the work efficiency and to make the computer uses more convenient, the work frequency of the information processing systems is continuously rising.

The core element of information processing systems is the central processing unit (CPU). It is an integrated circuit of many electronic elements. The circuit processes, controls and stores data used during operations. All operations, inputs/outputs (I/O), and connections to storage devices are monitored and controlled by the CPU.

Since the CPU has to perform all sorts of operations and tasks, its work frequency is extremely high. In a high-frequency work environment, one often has to worry about the problem of rising temperature. Moreover, high-frequency jobs consume a huge amount of power. It does not shorten the lifetime, lower the efficiency of the CPU, the large power consumption is another drawback.

### SUMMARY OF THE INVENTION

In view of the foregoing, the invention provides a dynamic clock pulse adjusting device. One of its objectives is to provide a mechanism to monitor the work conditions of the CPU and to automatically adjust the output clock pulse frequency accordingly. It can achieve the goals of increasing the work efficiency of the CPU and protecting the CPU at the same time.

To achieve the above objective, the disclosed dynamic clock pulse adjusting device uses a detection mechanism to monitor the CPU work temperature. The result is sent to a logic circuit to determine whether the work temperature exceeds a predetermined threshold. If the work temperature exceeds the predetermined threshold, the device outputs a frequency-lowering signal; if it is lower than the predetermined threshold, a frequency-raising signal is output. After a clock pulse generator receives the frequency-lowering or frequency-raising signal, it decreases or increases the output clock pulse frequency accordingly.

In addition, the detection mechanism can be used to monitor the CPU workload. The logic circuit uses the monitoring result to determine whether the CPU workload exceeds a predetermined threshold. If the workload is over the predetermined threshold, a frequency-raising signal is output to the clock pulse generator to increase the work frequency, and thus the CPU work efficiency. If the CPU workload is below the predetermined threshold, a frequency-lowering signal is output to the clock pulse generator to lower the frequency, avoiding unnecessary power consumption.

### BRIEF DESCRIPTION OF THE DRAWINGS

The invention will become more fully understood from the detailed description given hereinbelow illustration only, and thus are not limitative of the present invention, and wherein:

FIG. 1 is a schematic block diagram of the disclosed dynamic clock pulse adjusting device.

### DETAILED DESCRIPTION OF THE INVENTION

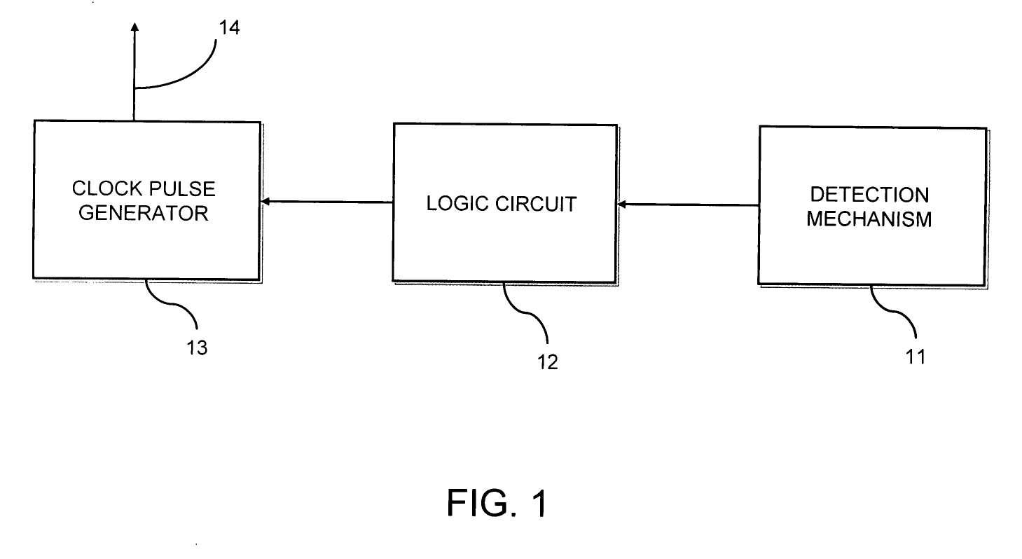

The disclosed dynamic clock pulse adjusting device, as schematically shown in FIG. 1, contains a detection mechanism 11, a logic circuit 12, and a clock pulse generator 13. The detection mechanism 11 monitors the work conditions of the CPU (not shown) in order to output a signal to the logic circuit 12. The logic circuit 12 then controls the output clock pulses 14 of the clock pulse generator 13 according to the CPU work conditions.

The detection mechanism 11 connects to a CPU (not shown) and detects the work temperature of the CPU via thermal sensing. The detected temperature signal is then converted into a digital signal for output.

The logic circuit 12 connects to the detection mechanism 11. After receiving the digital signal output from the detection mechanism 11, it determines whether the CPU work temperature exceeds a predetermined threshold according to a default temperature range. If the CPU work temperature is not over the threshold, a frequency-raising signal is output to the clock pulse generator 13. If the CPU work temperature is over the threshold, a frequency-lowering signal is output to the clock pulse generator 13.

The clock pulse generator 13 connects to the logic circuit for receiving the signals output from the logic circuit 12 and adjusts the frequency of its output clock pulse 14 accordingly. If the logic circuit 12 outputs a frequency-raising signal, the clock pulse generator 13 increases the frequency of its output clock pulses 14 to increase the CPU work efficiency. If the logic circuit 12 outputs a frequency-lowering signal, the clock pulse generator 13 lowers the frequency of its output clock pulses 14 to reduce the CPU work frequency.

Therefore, when the logic circuit determines that the detected CPU work temperature goes over the default temperature range, it outputs a frequency-lowering signal to the clock pulse generator 13, which then lowers the frequency of its output clock pulses 14. The work frequency and thus the work temperature of the CPU reduce to a normal range, protecting the CPU from overheating.

On the other hand, if the logic circuit 12 determines that the detected CPU work temperature is below the default temperature range, a frequency-raising signal is output to the clock pulse generator 13, which then increases the frequency of the output clock pulses 14. The work frequency of the CPU thereby increases for a better work efficiency.

On the other hand, the above-mentioned logic circuit 12 can be simplified to a resistor or a capacitor, which controls the electrical current to the clock pulse generator 13. The clock pulse generator 13 can adjust the frequency of its output clock pulses 14 according to the magnitude of the electrical current, increasing the CPU work efficiency or protecting the CPU from a high-temperature work environment.

Moreover, the disclosed detection mechanism 11 can be designed to monitor the CPU workload and outputs a corresponding signal to the logic circuit 12.

The logic circuit 12 uses the signal output from the detection mechanism 11 to determine whether the CPU workload exceeds a predetermined threshold. If the CPU workload is over the threshold, a frequency-raising signal is output to the clock pulse generator 13, which increases the frequency of its output clock pulses 14 accordingly. The CPU work frequency therefore increases for a better work efficiency. This can avoid the drawback that the CPU has slow reactions when its load is too high.

If the logic circuit 12 determines that the CPU workload is below the threshold, a frequency-lowering signal is output to the clock pulse generator 13, which then lowers the frequency of its output clock pulses 14. The work frequency of the CPU thus reduces to avoid unnecessary power consumption as a result of a work frequency higher than that needed by its current workload.

Certain variations would be apparent to those skilled in the art, which variations are considered within the spirit and scope of the claimed invention.

1. A dynamic clock pulse adjusting device for detecting and controlling the work conditions of a central processing unit (CPU), the dynamic clock pulse adjusting device comprising:
a detection mechanism, which connects to the CPU to detect a work temperature of the CPU via thermal sensing and converts a detected temperature signal into a digital signal for output;
a logic circuit, which connects to the detection mechanism for determining from the output signal of the detection mechanism whether the work temperature of the CPU exceeds a predetermined threshold and outputs a corresponding signal; and
a clock pulse generator, which connects to the logic circuit for adjusting the frequency of its output clock pulses according to the output signal from the logic circuit.

2. The dynamic clock pulse adjusting device of claim 1, wherein if the logic circuit determines the CPU work temperature exceeds a predetermined threshold a frequency-lowering signal is output to the clock pulse generator, which then lowers the frequency of its output clock pulses so that the work frequency and temperature of the CPU decrease.

3. The dynamic clock pulse adjusting device of claim 1, wherein if the logic circuit determines the CPU work temperature is below a predetermined threshold a frequency-raising signal is output to the clock pulse generator, which then raises the frequency of its output clock pulses so that the work efficiency of the CPU increases.

4. The dynamic clock pulse adjusting device of claim 1, wherein the logic circuit is a resistor.

5. The dynamic clock pulse adjusting device of claim 1, wherein the logic circuit is a capacitor.

6. A dynamic clock pulse adjusting device for detecting and controlling the work conditions of a central processing unit (CPU), the dynamic clock pulse adjusting device comprising:
a detection mechanism, which connects to the CPU to detect the CPU workload and outputs a signal;
a logic circuit, which connects to the detection mechanism for determining from the output signal of the detection mechanism whether the workload of the CPU exceeds a predetermined threshold and outputs a corresponding signal; and
a clock pulse generator, which connects to the logic circuit for adjusting the frequency of its output clock pulses according to the output signal from the logic circuit.

7. The dynamic clock pulse adjusting device of claim 6, wherein if the logic circuit determines the CPU workload exceeds a predetermined threshold a frequency-raising signal is output to the clock pulse generator, which then raises the frequency of its output clock pulses so that the work efficiency of the CPU increases.

8. The dynamic clock pulse adjusting device of claim 6, wherein if the logic circuit determines the CPU workload is below a predetermined threshold a frequency-lowering signal is output to the clock pulse generator, which then lowers the frequency of its output clock pulses so that the work efficiency of the CPU decreases.

9. The dynamic clock pulse adjusting device of claim 6, wherein the logic circuit is a resistor.

10. The dynamic clock pulse adjusting device of claim 6, wherein the logic circuit is a capacitor.
